(19) United States
(12) Patent Application Publication
(10) Pub. No.: US 2004/0174695 A1
(43) Pub. Date: Sep. 9, 2004

(54) Lighting device of an electro-luminescent lighting device

(76) Inventor: Jeng-Shyong Wu, Hsin-Chu City (TW)

Correspondence Address: McGLEW AND TUTTLE, P.C., SCARBOROUGH STATION, SCARBOROUGH, NY, 10510-0827, US

(21) Appl. No.: 10/657,694

(22) Filed: Sep. 8, 2003

(30) Foreign Application Priority Data
Mar. 5, 2003 (CN) 03201593.3

(51) Int. Cl. F21V 9/16

(52) U.S. Cl. 362/84

(57) ABSTRACT

A lighting device of an electro-luminescent lighting device (or electro-luminescent lamp) is composing of one or many kinds of electro-luminescent lighting device and bases. The electro-luminescent lighting device has the luminary and multiple individual extending electrodes. It is an isolator in one end of the electrode for the main body of lighting device; the other end is the surface of electric conductor, which is the extending of the main body of the electric conductor for the lighting device. There are many holes or crevices in the base going through two ends of the base. To use this extending electrode individually or simultaneously goes through this holes or crevices to fix the position; the luminary reveals in the one end of the main body of base, extending electrode reveals on the other end of said base, also bent the tail lean closely to the outside wall of the base, its isolator surface lean closely to outside wall. Its electric conductor face outward to the expected position of the power and connecting the luminary to the power, luminary performing expected shapes, colors, style, words or results.

### BACKGROUND OF THE INVENTION

The present invention relates to a kind of electro-luminescent lighting device. In more detail, it relates to a kind of using one or multiple electro-luminescent lamp and its base to form a laser lighting device of electro-luminescent. By means of modifying the structure, changing the shapes and color, applying implement in illumination device, decoration, warning and mark etc, whereby to invent the isolator in sealing and water-prove device, therefore it has the best safety.

Electro-luminescent (EL) or called laser was discovered in 1963, it is applying a phoneme of the lighting emittion formed by electric field. Nowadays there are many kinds of shapes being developed; such are flat shape, cylinder shape, hammer shape, 2-D, 3-D, board strip shape, slice shape, pipe shape, stick shape and narrow strip shape etc. They all have the colors and specifications but never get use widely in the daily life. The reasons are because of:

1. EL itself and connection problem. Generally they are uncovered in outdoors, or never been protected nicely, therefore dangerous.

2. Even through develop some shapes, colors and specifications but it always restricts in certain places or areas, therefore only can be used in the certain range.

3. EL itself uncovered in outdoors or contacting with other parts directly. They are very easy to cause the damage or even creates electric danger.

### SUMMARY OF THE INVENTION

The purpose of the present invention is to provide a kind of using electro-luminescent (EL) lamp and base to form a novel structure as a lighting device whereby to provide the stable combination of both.

According the present invention, the luminary of the EL lamp as a lighting device is composing of one or many kinds of EL lamps and bases. Thus EL lamp has a main body of lighting device and multiple individual extending electrodes. It is an isolator in the one side of the electrode as well as for the isolator of main body, the other side is the electric conductor of extending electrode. There are many holes or crevices in the bottom of the base, going through two ends of the base. To use this extending electrode individually or simultaneously to go through this holes or crevices to fixed position; the luminary reveals in the one end of the base, the extending electrode reveals on the other end of base, also bent the tail lean closely to the outside wall of the base, its isolator surface leans closely to outside wall. Its electric conductor surfaces outward the predetermined position of to the power and connecting the luminary to the power. Luminary is performing expected shapes, colors, style, words or results.

An electro-luminescent lighting device has a slim and flat shape, such as said electro-luminescent lighting device can be long strip, square, circle, star and many other kinds. Further, said lighting device also has many kind of expected (or predetermined) pictures, color or words. Said lighting device can be made of elastic material, such as hard and soft materials.

The enclosure is used to seal the electro-luminescent lighting device, fixed base and part pf electric conductor. The gap in the enclosure is filled with articles pervious to light, articles of light reflection, articles of light retraction or different color items. Said enclosure has open part to go through electro-luminescent lighting device and fixed on the base, said enclosure is composed of many pieces fixed on the base. The enclosure shapes can be pepper shapes, flame shape, circle shape, pipe shape, star shape and some specific designed shape. The enclosure can be transparent of translucent and many other predetermined colors. The enclosure colors are permeated into new material and attached to the inner surface or outer surface or the printing marks. The inner surface or the outer surface of the enclosure has rough-uneven lines. The enclosure also has hole. The enclosure is made of the hard and soft materials, in which the pictures, trademark, logo and advertising materials are provided. Further, the enclosure has single or multiple types, such as slim flat shape, panel, sheet, tube, bar, strip, cylinder shape, hammer shape, 2-dimentional lighting element or 3-dimentional lighting element. The filler items are the isolator to be used to separate the different electrodes.

The other light sources of the electro-luminescent lighting device can be incandescent lighting elements, fluorescent lighting elements, vacuum lamps, gas filled lamps, Halogen lighting elements or LED, etc.

The present invention also provides a method for manufacturing an electro-luminescent lighting-device. The procedures are as follows:

1. Putting the electric conductor on the fixed position base, two ends of electric conductor extending outside the fixed position base;

2. Making the electro-luminescent device having many electrodes, individually or together connected on one end of the electric conductor;

3. Making the other end of electric conductor individually or simultaneously go through holes, or clipping it between the crevices is the fixed position base, making the tail of electric conductor revealed outside the bottom base;

4. Using the enclosure containing the electric conductor, electro-luminescent lighting device, fixed position base and whole or part of base and fixed them on the base;

5. The tail of the electric conductor connecting with the power to luminary, shinning to establish (develop) the expected (predetermined) shapes, colors, pictures (graphs) or words.

In the present invention, the electro-luminescent lighting device has many electrodes, individually or simultaneously connected in one end of electric conductor and another end of electric conductor individually or simultaneously going through the holes, or clipping it between the crevices fixed position, making the tail of electric conductor revealed outside the bottom base, their procedures being able to be interchanged.

The electric conductor is fixed on the fixed position base, two ends of the electric conductor extending individually outside the fixed position bases; then putting the electro-luminescent lighting device with many electrodes, individually or simultaneously connected in one end of the electric conductor, then another end of the electric conductor individually or simultaneously going through the holes, or clipping it between the crevices in the fixed position, making the tail of the electric conductor revealed outside the base, then changing said electro-luminescent lighting device with many electrodes, individually or simultaneously connected in one end the electric conductor, then another end of the electric conductor individually or simultaneously going through the holes, or clipping it between the crevices in the fixed position, making the tail of the electric conductor revealed outside the base, then putting the electric conductor fixed on the fixed position base, two ends of the electric conductor extending separately on the fixed position base in sequence. Further, the parts mentioned above can be omitted in the structure, and the procedures are also able to be easier.

### BRIEF DESCRIPTION OF THE DRAWINGS

FIG. 1 is showing the perspective view of the electro-luminescent (EL) lighting device lamp of the present invention.

FIG. 2 is the first embodiment of disassembling view of the present invention.

FIG. 3 is the second embodiment of disassembling view of the present invention.

FIG. 4 is the third embodiment of disassembling view of the present invention.

FIG. 5 is the flat perspective view of the present invention.

FIG. 6 is another embodiment actual flat perspective view of the present invention.

FIG. 7 is the fourth embodiment of disassembling view of the present invention.

FIG. 8 is the perspective view of the snowman shape of the present invention.

FIG. 9 is the fifth embodiment of disassembling view of the present invention.

FIG. 10 is the series-parallel disassembling view of the present invention.

FIG. 11 is another kind of the perspective view of the pipe shape lighting device of electro-luminescent (EL) lighting device in the present invention.

FIG. 12 is a perspective view to use the connecter inside the lighting device of electro-luminescent (EL) lighting device in the present invention.

### DETAILED DESCRIPTION PREFERRED EMBODIMENTS

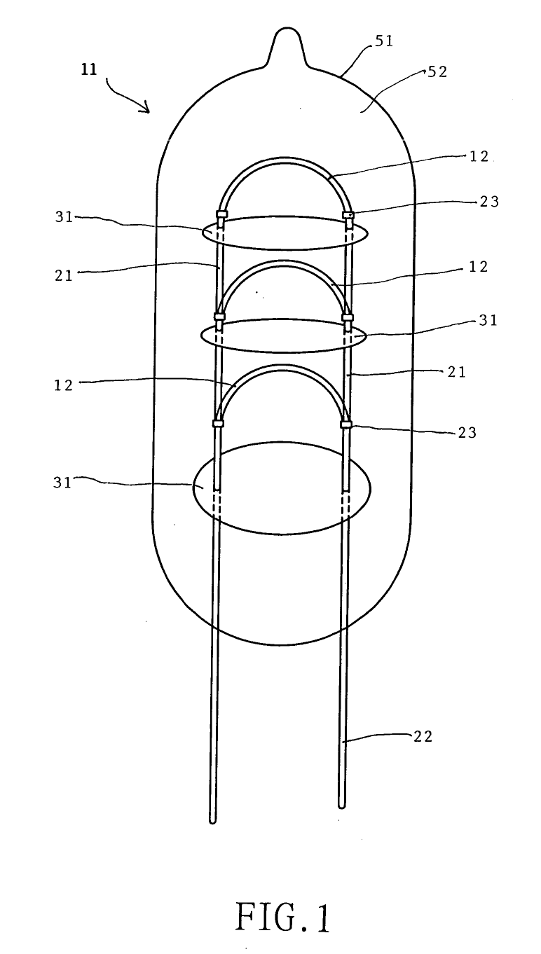

Referring to FIG. 1, two electric electric conductors 21 using multiple isolators such as glasses to fix on the fixed base 31 appearing parallel two electrodes. The multiple electro-luminescent (EL) lighting devices 11 have two diodes connecting with the electric conductor 21 individually. Their jointer 23 may be fixed via glued, press down or solder-up. The enclosure 51 is containing electro-luminescent (EL) lighting device 11, fixed base 31 and part of electric conductor 21. Expected area 52 that isolate with external world, reveal electric conductor 21 with its ending 22, thus electro-luminescent (EL) lighting device 11 lighten luminary 12 connect in parallel after connecting with power. Lighten them up simultaneously appearance multi-layer colors with expecting diagram or drawing.

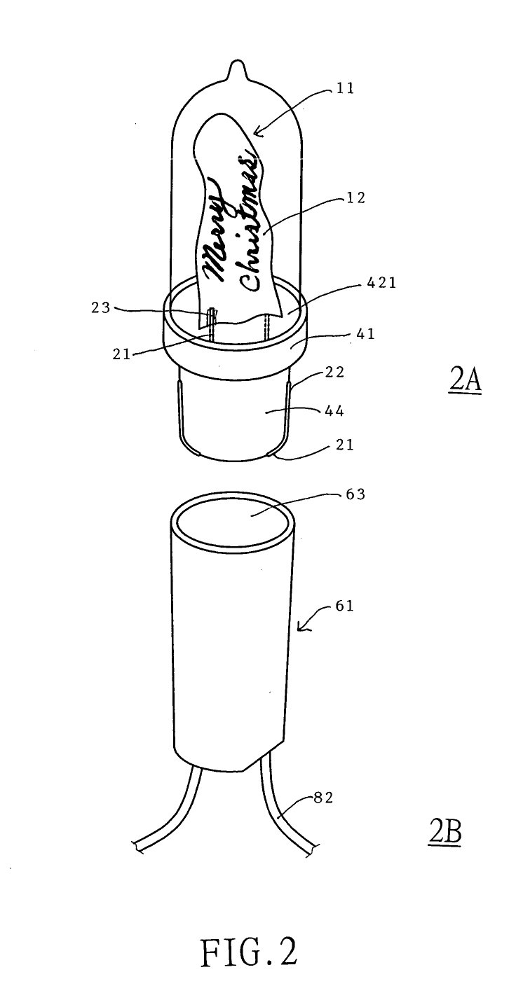

Referring to FIGS. 2, including 2A and 2B each end of two strings electric conductor 21 connect with slice shape of two electric pillars of the electro-luminescent (EL) lighting device 11. Their jointer 23 may be fixed via connect glued, press down or solder up. By using one ending 22 of electric conductor 21 go through the large end 421 of the hole in the base 41, the said large end 421 containing the part of electro-luminescent (EL) lighting device 11 and whole jointer 23. This ending 22 goes through the small hole extended to outside of the other end of the base 41. The ending 22 is bent and makes it closely to the outside wall 44 in the expected (predetermined) power point. The base 41 and the lamp holder 61 by pushing in style 63 to push in and connect with conductor wire 82. After turn on the power, the luminary 12 is lighting up and appearance its colors with expecting diagram such as word Merry Christmas.

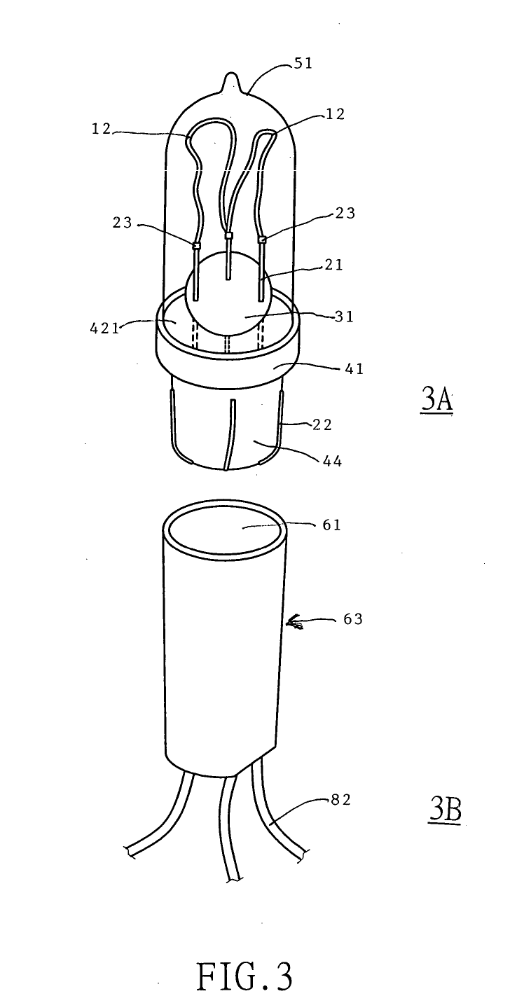

Referring to FIGS. 3, including 3A and 3B, three of electric conductor 21 use the isolator of the fixed base 31 to separate them apart. Thus two of the ending 22 are extended to the outside of the fixed base 31. By using the two relative (ending) electrodes in the electro-luminescent (EL) lighting device 11 connect with electric conductor 21, in which one end of the two electro-luminescent (EL) lighting devices 11 simultaneously connect with electric conductor 21 to become share electrode, another electrode of the electro-luminescent (EL) lighting device 11 that separately connect with electric conductors 21. Their jointer 23 is connected by different style. The other ending 22 of the electric conductor 21 goes through the hole in the base 41 to its large hole end 42. The said large hole end 42 includes part of electro-luminescent (EL) lighting device 11 and part of or whole part of the jointer 23, fixed base 31. Thus ending 22 goes through the small part of hole to extend to the outside of the other end of the base 41, by bending three ending 22 to make it closely to the outside wall 44 in the expected (predetermined) power point. The base 41 and the lamp holder 61 by pushing-in style 63 to push in and connect with three conductor wire 82, to be composed serial, parallel lighting or provides same or different electric rating. After turn on the power, the luminary 12 is lighting up and appearance its colors with expecting diagram.

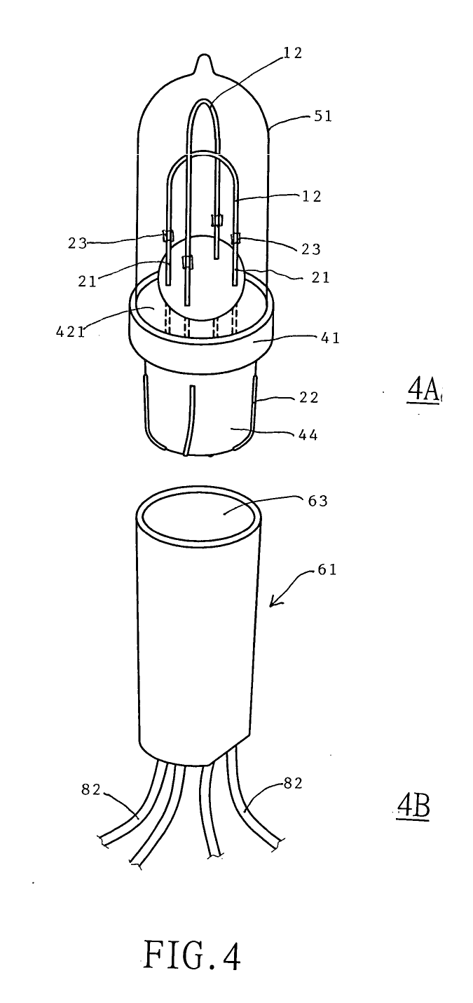

Referring to FIGS. 4, including 4A and 4B, four of electric conductor 21 use the isolator of the fixed base 31 to separate them apart. Thus two of the ending 22 are extended to the outside of the fixed base 31. By using the two relative ends of the electrode in the electro-luminescent (EL) lighting device 11 separately connect with one end of four electric conductor 21, their jointer 23 are connected by different style by every electric conductor 21 the other edge 22 go through the hole in the base 41 that four electric conductors 21 to its hole 42 includes electro-luminescent (EL) lighting device 11 and part of or whole part of the plug 23, fixed base 31. Thus end 22 goes through the small hole that extended to the outside of the other end of the base 41. By bending four end 22 make it closely to the outside wall 44 in the expect power point. The base 41 and the light head 61 by pushing style 63 into and connect with four conductor lines 82, composed with serial, parallel lighting or provides same or different electric rating. After turn on the power, thus luminary 12 lighting up appearance its colors with expecting diagram.

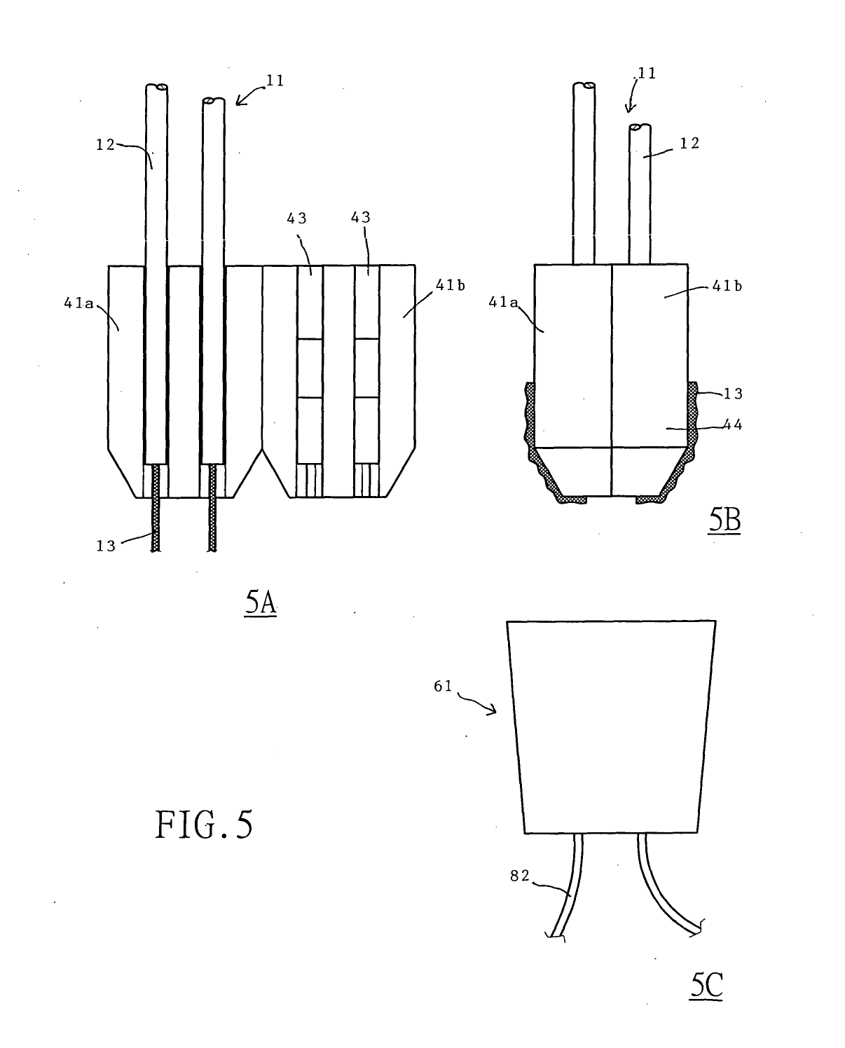

Referring FIGS. 5, including 5A, 5B and 5C, electro-luminescent (EL) lighting device 11 can by either flat, sheet, tube, bar, cylinder shape etc., having luminary 12 and electrode 13. The used base 41 is composed of a pair of slice base 41a, base 41b and a gap 43 between in them. Put the electro-luminescent (EL) lighting device 11 between the gap 43, to clip tightly with base 41a and base 41b, including part of luminary 12 and electrode 13, large part of luminary 12 reveals on the other end. Put electrode 13 bend and closely to the outside wall 44 in the expected (predetermined) power point. The base 41 and the lamp holder 61 by pushing-in style 63 to put in and connect with power. After turn on the power, the luminary 12 is lighting up and appearance its colors with expecting diagram.

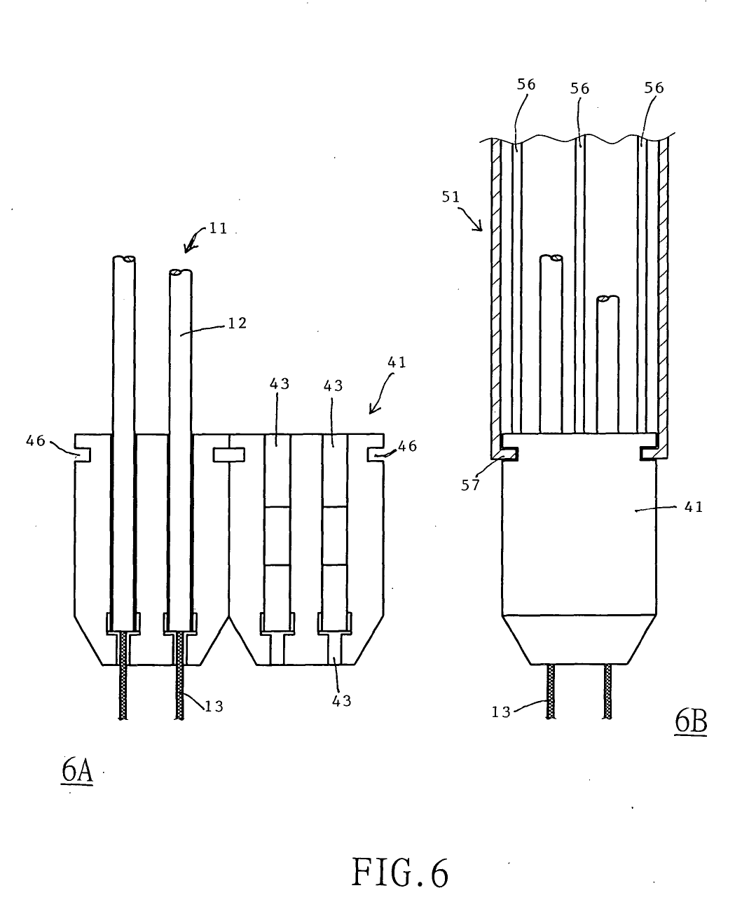

Referring FIG. 6, including 6A, 6B and 6C, electro-luminescent (EL) lighting device 11 can by either flat, sheet, tube, bar or cylinder shape etc., having luminary 12 and electrode 13. The used base 41 is composed of a pair slice base 41a, base 41b and a gap 43 between in them. Put the electro-luminescent (EL) lighting device 11 between the gap 43, to clip tightly with base 41a and base 41b, including of part luminary 12 and electrode 13, large part of luminary 12 reveals on the other end. The base 41 has the concave groove 46. The enclosure 51 isolator has the flange 57 to hook up tightly with the concave groove 46 and included within the electro-luminescent (EL) lighting device 11. Said enclosure 51 maybe a long tube shape, the length might be extended depends on the situation. Inside the inner wall of this enclosure 51, said inner wall may add rough and uneven surface 56 to increase the reflection and refraction affect. When providing power in electrode 13, electro-luminescent (EL) lighting device 11 appearance long and multiple style lighting device.

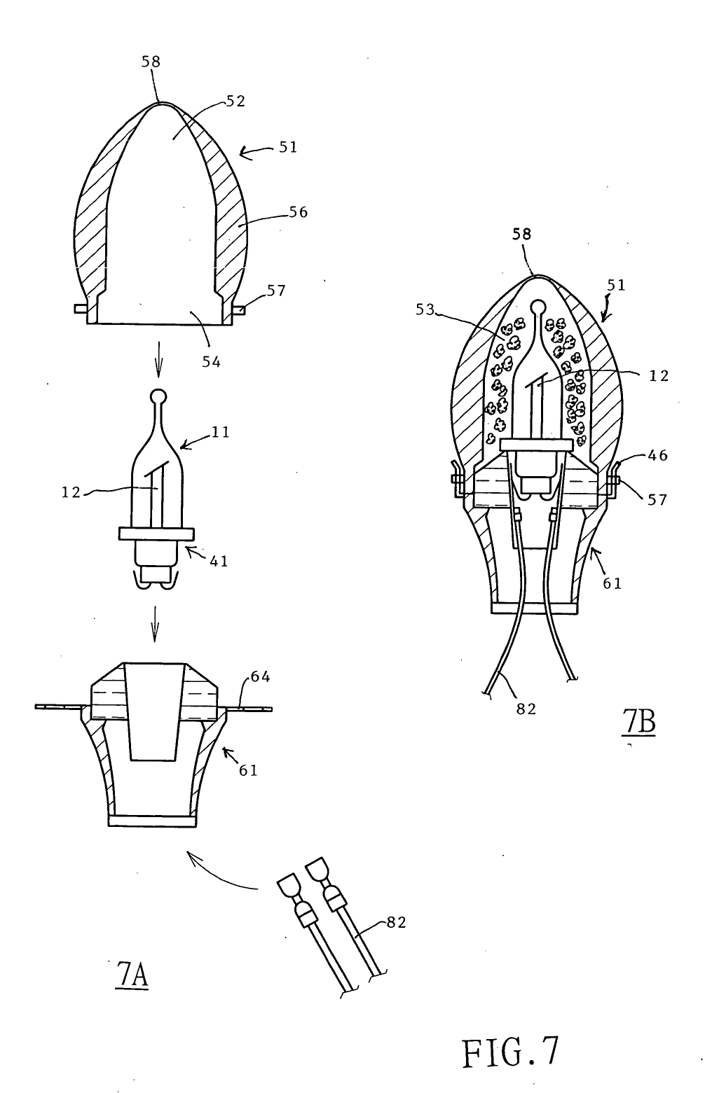

Referring FIG. 7, including 7A and 7B, an electro-luminescent (EL) lighting device 11 having a base 41 is equipped on the lamp holder 61, the jointer 23 is the power and connect with electro-luminescent (EL) lighting device 11. Said lamp holders 61 has the buckle 64 and also has a gap 52, the open edge area 54, rough-uneven surface 56, flange 57 and hole 58. The open edge area 54 fixes the electro-luminescent (EL) lighting device 11 in. The base 41 and part of the lamp holder 61 are to use the buckle 64 which to be bend and hook up the flange 57 to be fixed ton the position. Also to fill up with filler 53 in the gap 52 of the enclosure 51. The electro-luminescent (EL) lighting device 11 lightens up after the power is on, via filler 53, the rough-uneven surface 56 and enclosure 51 outer wall 44 reflect or refract out from the hole 58 to appearance expected diagram, shapes and colors.

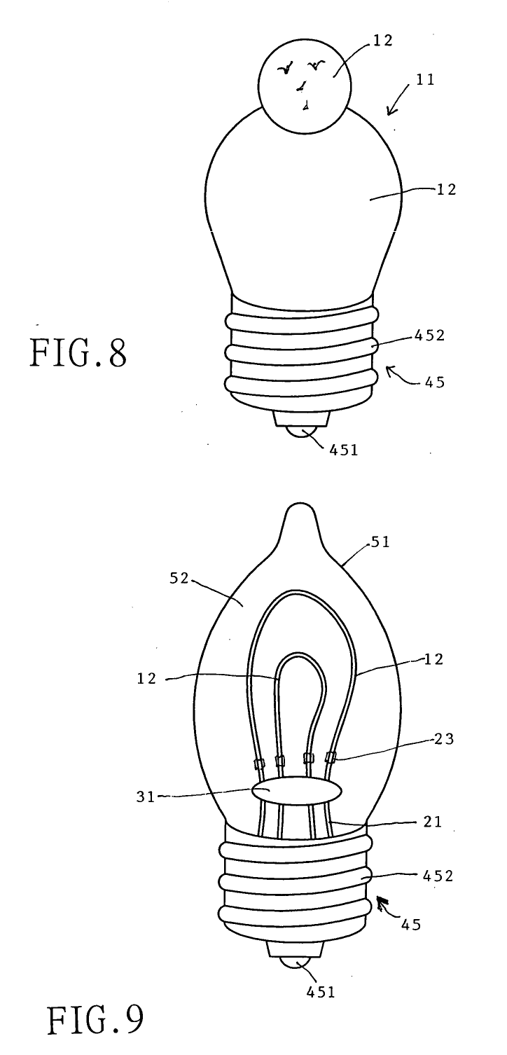

Referring FIG. 8, an electro-luminescent (EL) lighting device 11 as snowman shape installs on the device of a skew shape 45. The electric pillar of the electro-luminescent (EL) lighting device 11 connect into skew shape 45 respectively on the positive skew of the positive type 451 and on the negative skew of the negative type 452. To match skew shape lamp holder, the appearance of the snowman 3-D luminary device is obtained after the connection of the power.

Referring FIG. 9, an electro-luminescent (EL) lighting device 11 has many flat shape luminosity 12, simultaneously or individually connect on the multiple electric conductor 21, its jointer 23 may press, solder etc. Said multiple electric conductor 21 separately fixed on the fixed base 31. Another ends said electric conductor 21 are connected into skew shape 45 respectively on the positive skew of the positive type 451 and on the negative skew of the negative type 452. To match screw type lamp holder, the flames shape enclosure 51 including the luminosity 12, jointer 23, fixed base 31 are fixed in the gap 52. The multiple style lighting device is obtained and appearances the flames shape, multiple colors after switch on the power.

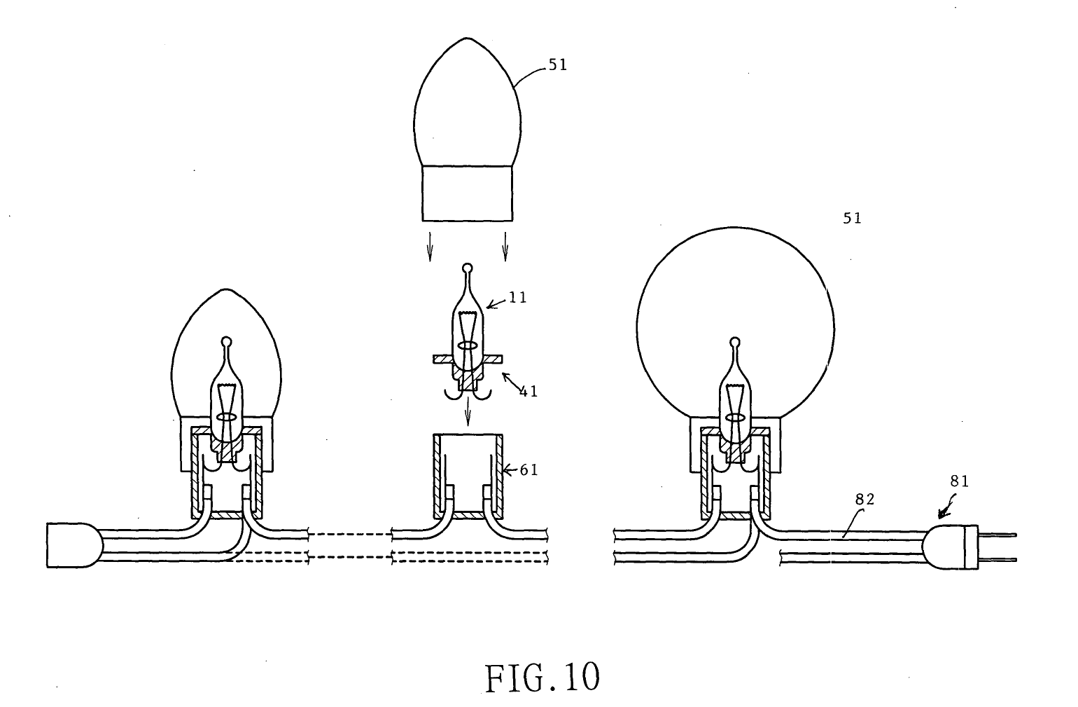

Referring FIG. 10, many electro-luminescent (EL) lighting devices 11 install in the base 41, lamp holder 61 and enclosure 51, and the conductor wire 82 is used to connect in serial and parallel. The power supply group 81 is to provide the power, appearing lighting device with serial parallel circuit. Many kinds of shape of enclosures 51, such as circle, flames etc. are used to appear many different shapes, colors of the lighting device.

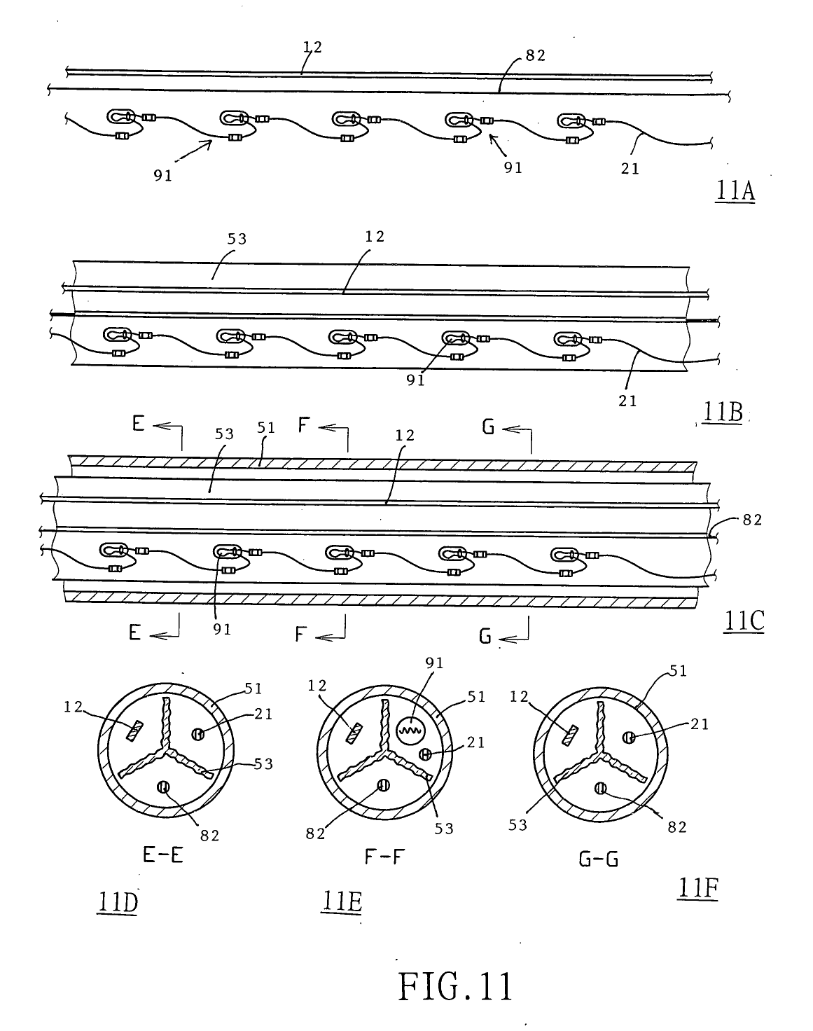

Referring FIGS. 11, including 11A, 11B, 11C, 11D, 11E and 11F, a kind of tube shape lighting device includes long strip luminosity 12, conductor wire 82 and other illuminate lighting source 91. A “Y” shape filler 53 is used as a isolator, and contained by the long tube shape enclosure 51. The parts are used together, and increase or decrease of parts in actually needed. The description in detail is not done here. The luminosity 12 and other illuminate lighting source 91 connect with same or different power, such connection have to see individual characters and use different electric rating or different circuit. After turn on the power, luminosity 12 appearance long strip lighting source, and other illuminate lighting source 91 appear dot shape lighting source, then the reflect or refract of filler 53 and outer wall 44 of enclosure 51 appears multiple change of long tube shape lighting device.

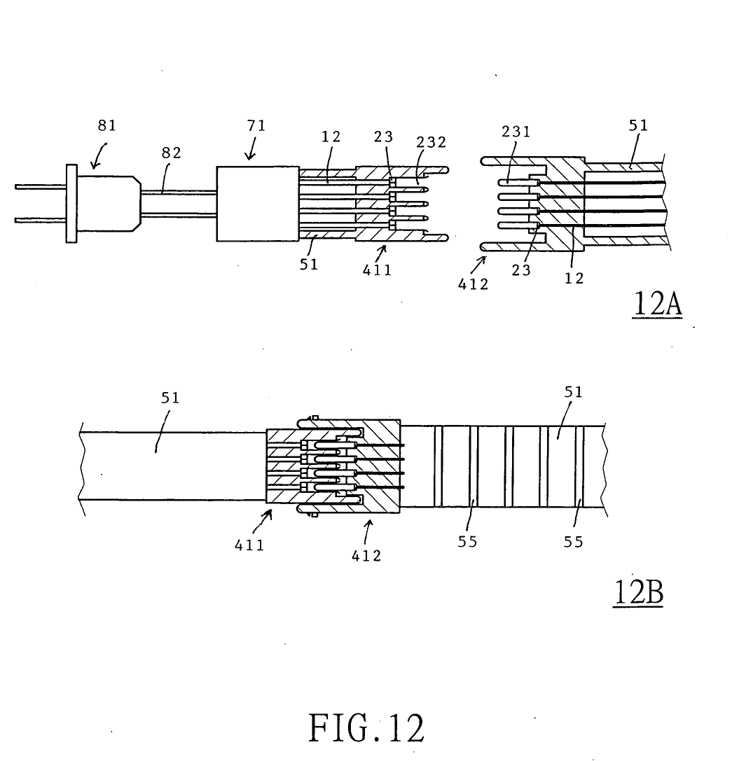

Referring FIGS. 12 including 12A and 12B, many luminosity 12 connect to the jointer 23 individually, and male jointer 231 or female jointer 232 are connected, then become the shape of male connect holder 411 and female connect holder 412. Said male connect holder 411 and female connect holder 412 can be continuously connected to form multiple long shape, also connect with transformer or controller device 71, conductor wire 82, power supply group 81, then to use the tube enclosure 51 containing the luminosity 12 and connect with male connect holder 411 and female connect holder 412. Or in the surface of the enclosure 51 appearing inner rough-uneven surface 55. The power supply group 81 is to provide the power via transformer or controller device 71, providing 38 output to every luminosity 12, to-form multiple change lighting device.

What is claimed is:

1. A lighting device of an electro-luminescent lighting device is composing of one or many kind of electro-luminescent lighting device and bases. The electro-luminescent lighting device has the luminary and multiple individual extending electrodes. It is an isolator in one end of the electrode for the main body of lighting device; the other end is the surface of electric conductor, which is the extending of the main body of the electric conductor for the lighting device. There are many holes or crevices in the base going through two ends of the base. To use this extending electrode individually or simultaneously goes through this holes or crevices to fix the position; the luminary reveals in the one end of the main body of base, extending electrode reveals on the other end of said base, also bent the tail lean closely to the outside wall of the base, its isolator surface lean closely to outside wall. Its electric conductor face outward to the expected position of the power and connecting the luminary to the power, luminary performing expected shapes, colors, style, words or results.

2. A lighting device of an electro-luminescent lighting device as claimed in claim 1, wherein an enclosure being used to contain electro-luminescent lighting device and whole part or part of the base, and every individual parts appearing gaps inside the enclosure.

3. A lighting device of an electro-luminescent lighting device as claimed in claim 2, wherein the gaps inside the enclosure filling with articles pervious to light, articles of reflection, articles of refraction or different color items.

4. A lighting device of an electro-luminescent lighting device as claimed in claim 3, wherein the filler items being isolator to separate the different electrodes.

5. A lighting device of an electro-luminescent lighting device as claimed in claim 2, wherein the enclosure having an open part to go through electro-luminescent lighting device and fixed on the base.

6. A lighting device of an electro-luminescent lighting device as claimed in claim 2; wherein the enclosure composed of many pieces fixed on the base.

7. A lighting device of an electro-luminescent lighting device as claimed in claim 2, wherein the shapes of enclosure being pepper shape, flame shape, circle shape, pipe shape, star shape and some specific designed shape.

8. A lighting device of an electro-luminescent lighting device as claimed in claim 2, Wherein the enclosure being transparent or half translucent and many other expected colors.

9. A lighting device of an electro-luminescent lighting device as claimed in claim 2, wherein the enclosure color permeated into raw material, attach to the inner or outer surface or printed marks.

10. A lighting device of an electro-luminescent lighting device as claimed in claim 2, wherein the inner surface or outer surface of the enclosure being rough-uneven lines.

11. A lighting device of an electro-luminescent lighting device as claimed in claim 2, wherein the enclosure having the hole.

12. A lighting device of an electro-luminescent lighting device as claimed in claim 2, wherein the enclosure being made of the hard and soft materials.

13. A lighting device of an electro-luminescent lighting device as claimed in claim 2, wherein the enclosure having pictures, trademark, logo and advertising materials.

14. A lighting device of an electro-luminescent lighting device as claimed in claim 1, wherein the enclosure having single or multiple types, such as slim flat shape, panel, sheet, tube, bar, strip, cylinder shape, hammer shape, 2-dimentional lighting element or 3-dimentional lighting element.

15. A lighting device of an electro-luminescent lighting device as claimed in claim 2, wherein the slim flat electro-luminescent lighting device being long strip, square, circle, star and many other kinds.

16. A lighting device of an electro-luminescent lighting device as claimed in claim 1, wherein the electro-luminescent lighting device having many kind of expected picture, color or words.

17. A lighting device of an electro-luminescent lighting device as claimed in claim 1, wherein the electro-luminescent lighting device being made of resilient material.

18. A lighting device of an electro-luminescent lighting device as claimed in claim 6, wherein the base being composed of two pieces or more.

19. A lighting device of an electro-luminescent lighting device as claimed in claim 18, wherein the appearing gaps formed by multiple pieces in the bases, for the holding part of electro-luminescent lighting device and the electrodes to be fixed and clipped up.

20. A lighting device of an electro-luminescent lighting device as claimed in claim 1, wherein the base having a hole, one end being bigger and the other end being smaller, the bigger end to put the main body of electro-luminescent lighting device in and the electrode through the smaller end to be revealed out.

21. A lighting device of an electro-luminescent lighting device as claimed in claim 1, wherein the electro-luminescent light device having neighbour electrodes, the electrodes going through the hole near the base, making the electro-luminescent lighting device flat or extending of predetermined bent.

22. A lighting device of an electro-luminescent lighting device as claimed in claim 1, wherein the electro-luminescent lighting device having not neighbour postion or opposite position of electrodes, said electrodes going through the hole of the next base to make the electro-luminescent appearing become bow, archway, circle, long circle shapes.

23. A lighting device of an electro-luminescent lighting device as claimed in claim 1, wherein the electro-luminescent lighting device to use the same or different direction, same or different angle to show the light source, flat or three dimensional, single face or multiple layer shapes to develop the expected diagram, words etc.

24. A lighting device of an electro-luminescent lighting device as claimed in claim 1, wherein the enclosure and base to be fixed and soldered up to seal tight, or to compose and to clip with many pieces of enclosures.

25. A lighting device of an electro-luminescent lighting device as claimed in claim 1, wherein the enclosure and base being fixed together to clip the bottom base, adhesives, hook and loop fasteners style to build up the strong structure.

26. A lighting device of an electro-luminescent lighting device as claimed in claim 1, wherein the electro-luminescent lighting device being able to mix and to use with other illuminate light source simultaneously to form the effects of more changes.

27. A lighting device of an electro-luminescent lighting device as claimed in claim 1, wherein the other light source of the electro-luminescent lighting device being incandescent lighting elements, fluorescent lighting elements, vacuum lamps, gas-filled lamps, Halogen lighting elements or LED.

28. A lighting device of an electro-luminescent lighting device as claimed in claim 1, wherein the electro-luminescent lighting device to use and to mix with different light source being to co-use or not to co-use, or to use the same or different electric rating.

29. A lighting device of an electro-luminescent lighting device as claimed in claim 1, wherein the electro-luminescent lighting device to use and to mix with different light source, being to co-use or not to co-use lamp holder.

30. A lighting device of an electro-luminescent lighting device as claimed in claim 1, wherein the base and the lamp holder receiving means to connect to power.

31. A lighting device of an electro-luminescent lighting device as claimed in claim 1, wherein the receiving means being for screw-in, push-in, wedge type, snap-in, pin connection to connect together and to electrify.

32. A lighting device of an electro-luminescent lighting device as claimed in claim 1, wherein the power of the electro-luminescent lighting device being the battery, lower voltage power, high voltage power or general home use power.

33. A lighting device of an electro-luminescent lighting device as claimed in claim 1, wherein the inverter circuity being installed between electro-luminescent lighting device and power.

34. A lighting device of an electro-luminescent lighting device as claimed in claim 1, wherein the inverter circuity including to exhibit a desired brightness and colors, controlling display functions, illumination duration, motion effects, illumination cycles, frequency of the cycles, vibration effects or on and off function.

35. A lighting device of an electro-luminescent lighting device being composed of one or many kinds of electro-luminescent lighting device, many electric conductors and bases, said electro-luminescent lighting device having a main body of lighting device and multiple electrodes, the base having many holes or crevices going through two ends of the base, the electric conductor having two ends, to use the electrodes of the electro-luminescent lighting device connected individually or together on one end of the electric conductor, the other end of electric conductor individually or together to go through the hole or crevices to fix position on the base, to make the tail of electric conductor reveal out of the base to connect the power, and connecting to the luminary after the power is switching, the luminary performing expected shapes, colors, styles, words or results.

36. A lighting device of an electro-luminescent lighting device as claimed in claim 35, wherein an enclosure being used to contain electro-luminescent lighting device, electric conductor and whole part or part of the base and every individual parts appearing gaps inside the enclosure.

37. A lighting device of an electro-luminescent lighting device as claimed in claim 36, wherein the gaps inside the enclosure, filling with article pervious to light, article of reflection, article of refraction or different color items.

38. A lighting device of an electro-luminescent lighting device as claimed in claim 37, wherein the filler items being isolator to separate the different electrodes.

39. A lighting device of an electro-luminescent lighting device as claimed in claim 36, wherein the enclosure having an open part to go through electro-luminescent lighting device and fixed on the base.

40. A lighting device of an electro-luminescent lighting device as claimed in claim 36, wherein the enclosure composed of many pieces fixed on the base.

41. A lighting device of an electro-luminescent lighting device as claimed in claim 36, wherein the shapes of enclosure being pepper shape, flame shape, circle shape, pipe shape, star shape and some specific designed shape.

42. A lighting device of an electro-luminescent lighting device as claimed in claim 36 wherein the enclosure being transparent or half translucent and many other expected colors.

43. A lighting device of an electro-luminescent lighting device as claimed in claim 36, wherein the enclosure color permeated into raw material, attach to the inner or outer surface or printed marks.

44. A lighting device of an electro-luminescent lighting device as claimed in claim 36, wherein the inner surface or outer surface of the enclosure being rough-uneven lines.

45. A lighting device of an electro-luminescent lighting device as claimed in claim 36, wherein the enclosure having the hole.

46. A lighting device of an electro-luminescent lighting device as claimed in claim 36, wherein the enclosure being made of the hard and soft materials.

47. A lighting device of an electro-luminescent lighting device as claimed in claim 36, wherein the enclosure having pictures, trademark, logo and advertising materials.

48. A lighting device of an electro-luminescent lighting device as claimed in claim 36, wherein the enclosure having single or multiple types, such as slim flat shape, panel, sheet, tube, bar, strip, cylinder shape, hammer shape, 2-dimentional lighting element or 3-dimentional lighting element.

49. A lighting device of an electro-luminescent lighting device as claimed in claim 48, wherein the slim flat electro-luminescent lighting device being long strip, square, circle, star and many other kinds.

50. A lighting device of an electro-luminescent lighting device as claimed in claim 35, wherein the electro-luminescent lighting device having many kind of expected picture, color or words.

51. A lighting device of an electro-luminescent lighting device as claimed in claim 35, wherein the electro-luminescent lighting device being made of resilient material.

52. A lighting device of an electro-luminescent lighting device as claimed in claim 35, wherein the base being composed of two pieces or more.

53. A lighting device of an electro-luminescent lighting device as claimed in claim 52, wherein the appearing gaps formed by multiple pieces in the bases, for holding the electro-luminescent lighting device, the fixed bases or the electric conductor to be fixed and clipped up.

54. A lighting device of an electro-luminescent lighting device as claimed in claim 35, wherein the base having a hole, one end being bigger and the other end being smaller, the bigger end to put the main body of electro-luminescent lighting device in and the electrode through the smaller end to be revealed out.

55. A lighting device of an electro-luminescent lighting device as claimed in claim 35, wherein the electro-luminescent light device having neighbour electrodes, the electrodes going through the hole near the base, making the electro-luminescent lighting device flat or extending of predetermined bent.

56. A lighting device of an electro-luminescent lighting device as claimed in claim 35, wherein the electro-luminescent lighting device having not neighbour position or opposite position of electrodes, said electrodes going through the hole of the next base to make the electro-luminescent appearing become bow, archway, circle, long circle shapes.

57. A lighting device of an electro-luminescent lighting device as claimed in claim 35, wherein the electro-luminescent lighting device to use the same or different direction, same or different angle to show the light source, flat or three dimensional, single face or multiple layer shapes to develop the expected diagram, words etc.

58. A lighting device of an electro-luminescent lighting device as claimed in claim 35, wherein the electro-luminescent lighting device being able to mix and to use with other illuminate light source simultaneously to form the effects of more changes.

59. A lighting device of an electro-luminescent lighting device as claimed in claim 35, wherein the other light source of the electro-luminescent lighting device being incandescent lighting elements, fluorescent lighting elements, vacuum lamps, gas-filled lamps, Halogen lighting elements or LED.

60. A lighting device of an electro-luminescent lighting device as claimed in claim 35, wherein the electro-luminescent lighting device to use and to mix with different light source being to co-use or not to co-use, or to use the same or different electric rating.

61. A lighting device of an electro-luminescent lighting device as claimed in claim 35, wherein the electro-luminescent lighting device to use and to mix with different light source, being to co-use or not to co-use lamp holder.

62. A lighting device of an electro-luminescent lighting device as claimed in claim 35, wherein the enclosure and base to be fixed and soldered up to seal tight, or to compose and to clip with many pieces of enclosures.

63. A lighting device of an electro-luminescent lighting device as claimed in claim 5, wherein the enclosure and base being fixed together to clip the bottom base, adhesives, hook and loop fasteners style to build up the strong structure.

64. A lighting device of an electro-luminescent lighting device as claimed in claim 35, wherein multiple bases connect with non-neighboured or opposite electrode and combination with the electric conductor, to form the long strip lighting device is the multiple bases.

65. A lighting device of an electro-luminescent lighting device as claimed in claim 35, wherein the strip lighting device appearing continuous or interval separate light.

66. A lighting device of an electro-luminescent lighting device as claimed in claim 35, wherein two ends of many electric conductors to form male and female pin to connect from head to tail of male-female to extend the length.

67. A lighting device of an electro-luminescent lighting device as claimed in claim 35, wherein two ends of bases to form the male and female pin containing the connector with male and female pin to connect from head to tail to extend the length.

68. A lighting device of an electro-luminescent lighting device as claimed in claim 35, wherein the electro-luminescent lighting device being able to mix and to use with other illuminate light source simultaneously to form the effects of more changes.

69. A lighting device of an electro-luminescent lighting device as claimed in claim 35, wherein the other light source of the electro-luminescent lighting device being incandescent lighting elements, fluorescent lighting elements, vacuum lamps, gas-filled lamps, Halogen lighting elements or LED.

70. A lighting device of an electro-luminescent lighting device as claimed in claim 35, wherein the electro-luminescent lighting device to use and to mix with different light source being to co-use or not to co-use, or to use the same or different electric rating.

71. A lighting device of an electro-luminescent lighting device as claimed in claim 35, wherein the electro-luminescent lighting device to use and to mix with different light source, being to co-use or not to co-use lamp holder.

72. A lighting device of an electro-luminescent lighting device as claimed in claim 35, wherein the base and the lamp holder receiving means to connect to power.

73. A lighting device of an electro-luminescent lighting device as claimed in claim 35, wherein the receiving means being for screw-in, push-in, wedge type, snap-in, pin connection to connect together and to electrify.

74. A lighting device of an electro-luminescent lighting device as claimed in claim 35, wherein the power of the electro-luminescent lighting device being the battery, lower voltage power, high voltage power or general home use power.

75. A lighting device of an electro-luminescent lighting device as claimed in claim 35, wherein the inverter circuity being installed between electro-luminescent lighting device and power.

76. A lighting device of an electro-luminescent lighting device as claimed in claim 35, wherein the inverter circuity including to exhibit a desired brightness and colors, controlling display functions, illumination duration, motion effects, illumination cycles, frequency of the cycles, vibration effects or on and off function.

77. A lighting device of an electro-luminescent lighting device being composed of one or many kinds of electro-luminescent lighting device, many electric conductors, at least one fixed position base and bases, two ends of the electric conductor to be fixed on the fixed position base and parts of said two ends extending outside the fixed position base, said electro-luminescent lighting device having a lighting device and multiple electrodes, said electrodes connected individually or together on one end of the electric conductor, the base having many holes or crevices going through two ends of the base, the other end of electric conductor individually or together to go through the hole or crevices to fix position on the base, to make the tail of electric conductor reveal out of the base to connect the power, and connecting to the luminary after the power is switching, the luminary performing expected shapes, colors, styles, words or results.

78. A lighting device of an electro-luminescent lighting device as claimed in claim 77, wherein an enclosure being used to contain electro-luminescent lighting device, electric conductor, fixed position base and whole part or part of the base, and every individual parts appearing gaps inside the enclosure.

79. A lighting device of an electro-luminescent lighting device as claimed in claim 78, wherein the gaps inside the enclosure filling with articles pervious to light, articles of reflection, articles of refraction or different color items.

80. A lighting device of an electro-luminescent lighting device as claimed in claim 79, wherein the filler items being isolator to separate the different electrodes.

81. A lighting device of an electro-luminescent lighting device as claimed in claim 78, wherein the enclosure having an open part to go through electro-luminescent lighting device and fixed on the base.

82. A lighting device of an electro-luminescent lighting device as claimed in claim 78, wherein the enclosure composed of many pieces fixed on the base.

83. A lighting device of an electro-luminescent lighting device as claimed in claim 78, wherein the shapes of enclosure being pepper shape, flame shape, circle shape, pipe shape, star shape and some specific designed shape.

84. A lighting device of an electro-luminescent lighting device as claimed in claim 78, wherein the enclosure being transparent or half translucent and many other expected colors.

85. A lighting device of an electro-luminescent lighting device as claimed in claim 78, wherein the enclosure color permeated into raw material, attach to the inner or outer surface or printed marks.

86. A lighting device of an electro-luminescent lighting device as claimed in claim 78, wherein the inner surface or outer surface of the enclosure being rough-uneven lines.

87. A lighting device of an electro-luminescent lighting device as claimed in claim 78, wherein the enclosure having the hole.

88. A lighting device of an electro-luminescent lighting device as claimed in claim 78, wherein the enclosure being made of the hard and soft materials.

89. A lighting device of an electro-luminescent lighting device as claimed in claim 78, wherein the enclosure having pictures, trademark, logo and advertising materials.

90. A lighting device of an electro-luminescent lighting device as claimed in claim 77, wherein the enclosure having single or multiple types, such as slim flat shape, panel, sheet, tube, bar, strip, cylinder shape, hammer shape, 2-dimentional lighting element or 3-dimentional lighting element.

91. A lighting device of an electro-luminescent lighting device as claimed in claim 77, wherein the slim flat electro-luminescent lighting device being long strip, square, circle, star and many other kinds.

92. A lighting device of an electro-luminescent lighting device as claimed in claim 77, wherein the electro-luminescent lighting device having many kind of expected picture, color or words.

93. A lighting device of an electroluminescent lighting device as claimed in claim 77, wherein the electro-luminescent lighting device being made of resilient material.

94. A lighting device of an electro-luminescent lighting device as claimed in claim 77, wherein the base being composed of two pieces or more.

95. A lighting device of an electro-luminescent lighting device as claimed in claim 77, wherein the appearing gaps formed by multiple pieces in the bases, for the holding part of electro-luminescent lighting device, fixed position base or the electrodes to be fixed and clipped up.

96. A lighting device of an electro-luminescent lighting device as claimed in claim 77, wherein the base having a hole, one end being bigger and the other end being smaller, the bigger end to put the main body of electro-luminescent lighting device, fixed position base or electric conductor in and the electric conductor through the smaller end to be revealed out.

97. A lighting device of an electro-luminescent lighting device as claimed in claim 77, wherein the electro-luminescent light device having neighbour electrodes, the electrodes connected with the neighbour electric conductor, making the electro-luminescent lighting device flat or extending of predetermined bent.

98. A lighting device of an electro-luminescent lighting device as claimed in claim 77, wherein the electro-luminescent lighting device having not neighbour position or opposite position of electrodes, said electrodes having a predetermined distance and connected with the electric conductor to make the electro-luminescent appearing becoming long, bow, archway, circle, long circle shapes.

99. A lighting device of an electro-luminescent lighting device as claimed in claim 77, wherein the electro-luminescent lighting device to use the same or different direction, same or different angle to show the light source, flat or three dimensional, single face or multiple layer shapes to develop the expected diagram, words etc.

100. A lighting device of an electro-luminescent lighting device as claimed in claim 77, wherein the electro-luminescent lighting having every electrodes, connected individually or together with the electric conductor, using solder up, glued, press down, or surrounding connected style.

101. A lighting device of an electro-luminescent lighting device as claimed in claim 77, wherein every electrodes of the electro-luminescent lighting device, being mutual connected to one string with the electric conductor to form series circuitry.

102. A lighting device of an electro-luminescent lighting device as claimed in claim 77, wherein every electrodes of the electro-luminescent lighting device with the same polarity being connected in one electric conductor, using the different polarity of electric conductors to form parallel circuitry.

103. A lighting device of an electro-luminescent lighting device as claimed in claim 77, wherein every electrodes of the electro-luminescent lighting device, being able to use the same or different electrodes mutual connected in the electric conductor to form series-parallel circuitry.

104. A lighting device of an electro-luminescent lighting device as claimed in claim 77, wherein the fixed position base being on isolator to fix many electric conductors separately on the fixed position.

105. A lighting device of an electro-luminescent lighting device as claimed in claim 77, wherein the isolator being glass material for containing the electric conductor.

106. A lighting device of an electro-luminescent lighting device as claimed in claim 77, wherein the enclosure and base to be fixed and soldered up to seal tight, or to compose and to clip with many pieces of enclosures.

107. A lighting device of an electro-luminescent lighting device as claimed in claim 77, wherein the enclosure and base being fixed together to clip the bottom base, adhesives, hook and loop fasteners style to build up the strong structure.

108. A lighting device of an electro-luminescent lighting device as claimed in claim 77, wherein the electro-luminescent lighting device being able to mix and to use with other illuminate light source simultaneously to form the effects of more changes.

109. A lighting device of an electro-luminescent lighting device as claimed in claim 77, wherein the other light source of the electro-luminescent lighting device being incandescent lighting elements, fluorescent lighting elements, vacuum lamps, gas-filled lamps, Halogen lighting elements or LED.

110. A lighting device of an electro-luminescent lighting device as claimed in claim 77, wherein the electro-luminescent lighting device to use and to mix with different light source being to co-use or not to co-use, or to use the same or different electric rating.

111. A lighting device of an electro-luminescent lighting device as claimed in claim 77, wherein the electro-luminescent lighting device to use and to mix with different light source, being to co-use or not to co-use lamp holder.

112. A lighting device of an electro-luminescent lighting device as claimed in claim 77, wherein the base and the lamp holder receiving means to connect to power.

113. A lighting device of an electro-luminescent lighting device as claimed in claim 77, wherein the receiving means being for screw-in, push-in, wedge type, snap-in, pin connection to connect together and to electrify.

114. A lighting device of an electro-luminescent lighting device as claimed in claim 77, wherein the power of the electro-luminescent lighting device being the battery, lower voltage power, high voltage power or general home use power.

115. A lighting device of an electro-luminescent lighting device as claimed in claim 77, wherein the inverter circuity being installed between electro-luminescent lighting device and power.

116. A lighting device of an electro-luminescent lighting device as claimed in claim 77, wherein the inverter circuity including to exhibit a desired brightness and colors, controlling display functions, illumination duration, motion effects, illumination cycles, frequency of the cycles, vibration effects or on and off function.

117. A method for manufacturing an electro-luminescent lighting device as follows:
6. Putting the electric conductor on the fixed position base, two ends of electric conductor extending outside the fixed position base;
7. Making the electro-luminescent device having many electrodes, individually or together connected on one end of the electric conductor;
8. Making the other end of electric conductor individually or simultaneously go through holes, or clipping it between the crevices is the fixed position base, making the tail of electric conductor revealed outside the bottom base.
9. Using the enclosure containing the electric conductor, electro-luminescent lighting device, fixed position base and whole or part of base and fixed them on the base.
10. The tail of the electric conductor connecting with the power to luminary, shinning to establish (or develop) the expected (or predetermined) shapes, colors, pictures (or graphs) or words.

118. A method for manufacturing an electro-luminescent lighting device as claimed in claim 117, wherein the electro-luminescent lighting device having many electrodes, individually or simultaneously connected in one end of electric conductor and another end of electric conductor individually or simultaneously going through the holes, or clipping it between the crevices fixed position, making the tail of electric conductor revealed outside the bottom base, their procedures being able to be interchanged.

119. A method for manufacturing an electro-luminescent lighting device as claimed in claim 117, wherein the electric conductor being fixed on the fixed position base, two ends of the electric conductor extending individually outside the fixed position base and one end of the electric conductor, individually or simultaneously going through the holes, or clipping it between the crevices fixed position, making the tail of the electric conductor tail revealed outside the base, their procedures being able to be interchanged.

120. A method for manufacturing an electro-luminescent lighting device methods as claimed in claim 117, wherein the electric conductor being fixed on the fixed position base, two ends of the electric conductor extending individually outside the fixed position base; the electro-luminescent lighting device having many electrodes, individually or simultaneously connected in one end of electric conductor, their procedures being able to be interchanged.

121. A method for manufacturing an electro-luminescent lighting device as claimed in claim 117, wherein the electric conductor being fixed on the fixed position base, two ends of the electric conductor extending individually outside the fixed position bases; then putting the electro-luminescent lighting device with many electrodes, individually or simultaneously connected in one end of the electric conductor, then another end of the electric conductor individually or simultaneously going through the holes, or clipping it between the crevices in the fixed position, making the tail of the electric conductor revealed outside the base, then changing said electro-luminescent lighting device with many electrodes, individually or simultaneously connected in one end the electric conductor, then another end of the electric conductor individually or simultaneously going through the holes, or clipping it between the crevices in the fixed position, making the tail of the electric conductor revealed outside the base, then putting the electric conductor fixed on the fixed position base, two ends of the electric conductor extending separately on the fixed position base in sequence.

122. A method for manufacturing an electro-luminescent lighting device as claimed in claim 117, wherein the parts being able to be omitted in the structure, the procedure being also able to be easier.
